(19) United States
(12) Patent Application Publication
(10) Pub. No.: US 2026/0014594 A1
(43) Pub. Date: Jan. 15, 2026

(54) CLEANING METHOD OF SUSCEPTOR

(71) Applicant: GLOBALWAFERS JAPAN CO., LTD., Niigata (JP)

(72) Inventors: Ken HAYAKAWA, Niigata (JP); Haruo Sudo, Niigata (JP); Toshiro Minami, Niigata (JP)

(21) Appl. No.: 19/262,558

(22) Filed: Jul. 8, 2025

(30) Foreign Application Priority Data
Jul. 9, 2024 (JP) 2024-110232

(51) Int. Cl. B08B 3/08; B08B 11/00; B24B 1/00

(52) U.S. Cl. CPC B08B 3/08; B08B 11/00; B24B 1/00

(57) ABSTRACT

Provided is a cleaning method of a susceptor including a base material; and an oxide film formed on the surface of the base material. The thickness of the oxide film after heat treatment is smaller in a contact region in which the susceptor is in contact with a semiconductor substrate, than in a non-contact region, The cleaning method includes (i) a step of removing the oxide film such that the base material is not exposed in the contact region; or (ii) a step in which each time an oxide film having a predetermined thickness within the range of 1 μm or more and 30 μm or less is newly formed in the non-contact region, the oxide film is removed such that the difference between the thicknesses of the portions of the oxide film in the contact and non-contact regions is 5 μm or less.

### TECHNICAL FIELD

The present invention relates to a cleaning method of a susceptor that supports a semiconductor substrate during heat treatment.

### BACKGROUND ART

Numerous crystal defects such as grown-in defects are present on the surfaces and surface layers of semiconductor substrates (hereinafter, referred to as wafers) such as silicon grown by the Czochralski process (CZ method) and the like. These crystal defects cause failures during the manufacture of semiconductor devices. Thus, the surfaces and surface layers of the wafers are required to be substantially defect-free.

As one of the methods for eliminating defects on the surfaces and surface layers of the wafers, rapid thermal annealing using a rapid thermal annealing apparatus 1 illustrated in FIG. 9, for example, has been known (hereinafter, the rapid thermal annealing apparatus 1 is simply referred to as an RTA apparatus 1; and the rapid thermal annealing is simply referred to as RTA treatment). In the RTA treatment, when a wafer 2 is rapidly heated to a high-temperature region, held at a high temperature for a predetermined period of time, and then rapidly cooled, crystal defects on the surface and surface layer of the wafer 2 disappear, and bulk micro defects (BMDs) are formed at high density in a bulk portion below the surface layer.

The BMDs in the bulk portion act as gettering sites in which metal impurities are captured, the metal impurities diffusing in the wafer 2 during the manufacture of semiconductor devices and causing device failures. BMDs are formed in the RTA treatment in this way, thereby enabling the manufacture of the wafer 2 of high quality and resistant to metal contamination. In this RTA treatment, since the wafer 2 is heat-treated at high temperatures, the wafer 2 is largely affected by surrounding members and the environment. In particular, since a susceptor 3 that supports the wafer 2 during the RTA treatment is in direct contact with the wafer 2 under high-temperature heat treatment, the susceptor 3 is required to have the high heat resistance and to be a high-purity member with less contamination. Thus, silicon carbide (SiC) is generally used as the material of the susceptor 3.

In the manufacture of the susceptor 3, made of SiC, for the RTA apparatus 1, for example, the below-identified Patent Document 1 proposes a method of manufacturing SiC members each having a high-purity oxide film obtained by forming an oxide film by wet baking, then performing thickness control for the oxide film by hydrofluoric acid treatment.

When the wafer 2 is heat-treated with the RTA apparatus 1, a trace of contamination due to Fe or the like remaining on the back side of the wafer 2 is transferred to the susceptor 3. The contamination accumulated on the susceptor 3 as a result of this transfer is possibly re-transferred to the vicinity of a region for supporting an end of another wafer 2 to contaminate the other wafer 2. It is hence necessary to remove the contamination on the surface of the wafer by cleaning the susceptor 3. As a cleaning method of the susceptor 3, for example, the below-identified Patent Document 2 proposes a method of removing a contamination source by supplying a fluorine-containing gas turned into plasma and oxygen-containing gas to a susceptor made of SiC.

### PRIOR ART DOCUMENTS

### Patent Documents

Patent Document 1: Japanese Unexamined Patent Application Publication No. 2020-83734
Patent Document 2: Japanese Unexamined Patent Application Publication No. 2015-53393

### SUMMARY OF THE INVENTION

### Problems to be Solved by the Invention

The RTA treatment is desirably performed in the temperature range of not less than 1250° C. and not more than the melting point of the wafer 2 under an oxygen atmosphere in order to eliminate the defects on the surface and surface layer of the wafer 2 and to form the BMDs in the bulk portion. When the RTA treatment is repeatedly performed under this heat treatment condition, as illustrated in FIGS. 10A to 10C, an oxide film 3b (initial thickness of about 0.1 μm) gradually grows on the surface of the susceptor 3 made of SiC. Note that in each of the drawings in the present application, the film thickness of the oxide film 3b is depicted in an exaggerated manner for easy viewing of the cross-sectional shape of the oxide film 3b.

The growth rate of the oxide film 3b formed during the RTA treatment is lower in a contact region 6 in which the susceptor 3 and the wafer 2 are in contact with each other, than in a non-contact region 7 other than the contact region 6. Hence, as illustrated in FIG. 11, a difference is created between film thicknesses of the oxide film 3b in the contact region 6 in which the susceptor 3 and the wafer 2 are in contact with each other, and in the non-contact region 7. As a result, a state of supporting the wafer 2 during the RTA treatment becomes unstable (see FIG. 10C), and slips are likely to occur in the wafer 2 due to the concentration of the self-weight stress and the thermal stress of the wafer 2. Moreover, when the thickness of the oxide film 3b on the surface of the susceptor 3 reaches 20 μm or more, the oxide film 3b peels off and the possibility raises of developing light point defects (LPDs), which is one of the surface defects of the wafer 2.

For example, it can be considered that the cleaning method according to Patent Document 2 is employed to clean the surface of the susceptor 3, but the cleaning method according to Patent Document 2 is intended to remove deposits made of SiC on the surface of the susceptor 3, and it is not appropriate to directly apply this method to the removal of the oxide film 3b on the surface of the susceptor 3.

It is an object of the present invention to provide a cleaning method of a susceptor by which it is possible to prevent deterioration of the quality of a semiconductor substrate due to an oxide film formed on the surface of the susceptor.

### Means for Solving the Problems

In order to achieve the above object, the present invention provides a cleaning method of a susceptor supporting a semiconductor substrate during heat treatment, and comprising: a base material; and an oxide film formed on a surface of the base material, wherein a thickness of the oxide film after the heat treatment is smaller in a contact region in which the susceptor is in contact with the semiconductor substrate, than in a non-contact region other than the contact region, and wherein the cleaning method comprises an oxide film thinning step of removing the oxide film by etching such that the base material is not exposed in the contact region (arrangement 1).

By thus reducing the thickness of the oxide film with the oxide film thinning step, the boundary between the portion of the oxide film formed in the contact region, in which the susceptor and the wafer are in contact with each other, and the portion of the oxide film formed in the non-contact region is made smooth, support of the wafer by the susceptor is stabilized, and the concentration of the self-weight stress and the thermal stress of the wafer are alleviated. Therefore, generation of slips during RTA treatment is reduced, and the quality of the wafer improves.

In the first arrangement, a second arrangement is preferably used in which each time the oxide film having a predetermined thickness within a range of 0.1 μm or more and 5 μm or less is newly formed in the contact region by the heat treatment, in the oxide film thinning step, the oxide film is removed within a range of the thickness of the oxide film newly formed in the contact region. If, as described above, each time the oxide film having a predetermined thickness is formed in the contact region, the oxide film is removed in the oxide film thinning step, it is possible to extend the life of the susceptor, and to ensure high quality of the wafer subjected to RTA treatment using the susceptor. If the thickness of the oxide film in the contact region is less than 0.1 μm, this is less likely to adversely affect the quality of the wafer, whereas if the thickness of the oxide film in the contact region is more than 5 μm, this could adversely affect the quality of the wafer. Therefore, it is preferable to set the thickness within the above range.

In the first arrangement and the second arrangement, a third arrangement is preferably used in which the oxide film thinning step is performed in a state in which a crack extending from a surface of the oxide film toward an interior of the oxide film is not present in the oxide film after the heat treatment. By performing the oxide film thinning step in a state in which a crack is not present in the oxide film, etching progresses only from the surface of the oxide film, that is, a situation does not occur in which an etching solution infiltrates into a crack, and etching progresses from the interior of the oxide film. Therefore, it is possible to easily control the film thickness of the oxide film in the oxide film thinning step, and to prevent non-uniformity of the oxide film thickness.

In the first to third arrangements, a fourth arrangement is preferably used in which the cleaning method of the susceptor further comprises an oxide film polishing step of removing the oxide film on a surface of the susceptor by polishing, subsequent to the oxide film thinning step. In the oxide film polishing step, the portion of the oxide film in the non-contact region, in which the film thickness is larger, is first polished so as to reduce difference between oxide film thicknesses in the contact region and the non-contact region. This alleviates the concentration of the self-weight stress and the thermal stress of the wafer due to the difference in oxide film thickness, thus further reducing generation of slips during RTA treatment.

In the fourth arrangement, a fifth arrangement is preferably used in which each time the oxide film having a predetermined thickness within a range of 1 μm or more and 30 μm or less is newly formed in the non-contact region by the heat treatment, in the oxide film polishing step, the oxide film is removed within the range of the thickness of the oxide film newly formed in the non-contact region such that a difference between thicknesses of a portion of the oxide film in the contact region and a portion of the oxide film in the non-contact region is 5 μm or less. If, as described above, each time the film having a predetermined thickness is formed in the non-contact region, the oxide film is removed in the oxide film polishing step, the portion of the oxide film in the non-contact region, in which the film thickness is larger, is first polished so as to reduce the difference between the oxide film thicknesses in the contact region and the non-contact region. This alleviates the concentration of the self-weight stress and the thermal stress of the wafer due to the difference in oxide film thickness, thus further reducing generation of slips during RTA treatment. If the film thickness of the oxide film in the non-contact region is less than 1 μm, this is less likely to adversely affect the quality of the wafer, whereas if the thickness of the oxide film in the non-contact region is more than 30 μm, this could adversely affect the quality of the wafer. Therefore, it is preferable to set the film thickness within the above range. Especially if the difference between the thicknesses of the portions of the oxide film in the contact region and in the non-contact region is 5 μm or less, the wafer is supported stably, and this further effectively reduces generation of slips during RTA treatment.

In order to achieve the above object, the present invention also provides a cleaning method of a susceptor supporting a semiconductor substrate during heat treatment, and comprising: a base material; and an oxide film formed on a surface of the base material, wherein a thickness of the oxide film after the heat treatment is smaller in a contact region in which the susceptor is in contact with the semiconductor substrate, than in a non-contact region other than the contact region, and wherein the cleaning method comprises an oxide film polishing step in which each time the oxide film having a predetermined thickness within a range of 1 μm or more and 30 μm or less is newly formed in the non-contact region by the heat treatment, the oxide film is removed within a range of the thickness of the oxide film newly formed in the non-contact region such that a difference between thicknesses of a portion of the oxide film in the contact region and a portion of the oxide film in the non-contact region is 5 μm or less (arrangement 6).

With this arrangement, as with the fifth arrangement, the difference between the oxide film thicknesses in the contact region and in the non-contact region decreases, and this alleviates the concentration of the self-weight stress and the thermal stress of the wafer due to the difference in oxide film thickness. Therefore, generation of slips during RTA treatment is further reduced. Especially if the difference between the thicknesses of the portions of the oxide film in the contact region and in the non-contact region is 5 μm or less, the wafer is supported stably, and thus generation of slips during RTA treatment is further effectively reduced.

In the first to sixth arrangements, a seventh arrangement is preferably used in which a surface roughness Ra of the oxide film formed in the susceptor is within a range of 0.01 μm or more and 1 μm or less. If the surface roughness Ra is within this range, it is possible to appropriately maintain the contact area between the wafer and the susceptor, and to reduce generation of slips due to the self-weight stress and the thermal stress of the wafer. If the surface roughness Ra is less than 0.01 μm, this increases the contact area between the wafer and the susceptor, and slips due to welding between the wafer and the susceptor are likely to occur during RTA treatment. If the surface roughness Ra is more than 1 μm, this decreases the contact area between the wafer and the susceptor, and slips due to the concentration of self-weight stress is likely to occur. Therefore, it is preferable to set the surface roughness Ra within the above range.

In the first to seventh arrangements, an eighth arrangement is preferably used in which a heat treatment temperature is within a range of not less than 1250° C. and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen. By applying the above cleaning method to the susceptor used in RTA treatment using the above heat treatment conditions, it is possible to reduce generation of slips caused by unstable support of the wafer during the RTA treatment and generation of LPDs due to separation of the oxide film, and to keep the surface state of the susceptor so as not to affect the wafer quality.

### Effects of the Invention

According to the above invention, since the oxide film formed on the surface of the susceptor can be appropriately removed, deterioration of the wafer quality due to this oxide film can be prevented.

### BRIEF DESCRIPTION OF THE DRAWINGS

FIG. 1 is a flowchart illustrating a first embodiment of a cleaning method of a susceptor according to the present invention.

FIGS. 2A and 2B are sectional views illustrating a change in shape of a wafer in the cleaning method illustrated in FIG. 1, in which FIG. 2A is a view before cleaning; and FIG. 2B is a view after an oxide film thinning step.

FIG. 3 is a flowchart illustrating a second embodiment of the cleaning method of a susceptor according to the present invention.

FIGS. 4A to 4C are sectional views illustrating a change in shape of a wafer in the cleaning method illustrated in FIG. 3, in which FIG. 4A is a view before cleaning; FIG. 4B is a view after an oxide film polishing step; and FIG. 4C is a view after etching followed by the oxide film polishing step.

FIG. 5 is a flowchart illustrating a third embodiment of the cleaning method of a susceptor according to the present invention.

FIGS. 6A to 6D are sectional views illustrating a change in shape of a wafer in the cleaning method illustrated in FIG. 5, in which FIG. 6A is a view before cleaning; FIG. 6B is a view after the oxide film thinning step; FIG. 6C is a view after the oxide film polishing step; and FIG. 6D is a view after etching followed by the oxide film polishing step.

FIG. 7A illustrates a measurement result of the distortion area ratio of a wafer subjected to RTA treatment using a susceptor cleaned by the cleaning method illustrated in FIG. 1; FIG. 7B illustrates a measurement result of the bulk Fe concentration in the outer periphery of the wafer; and FIG. 7C illustrates a measurement result of LPDs of the wafer.

FIG. 8 illustrates a measurement result of the distortion area ratio of a wafer subjected to RTA treatment using a susceptor cleaned by the cleaning method illustrated in FIG. 3.

FIG. 9 is a sectional view illustrating an RTA apparatus as an example.

FIGS. 10A to 10C are enlarged sectional views of a portion illustrating a change in surface shape of a susceptor due to RTA treatment, in which FIG. 10A illustrates an initial stage of use of the susceptor; FIG. 10B illustrates an intermediate stage of use of the susceptor; and FIG. 10C is the last stage of use of the susceptor.

FIG. 11 is an enlarged cross-sectional view illustrating a main section in the last stage of use of the susceptor.

### BEST MODE FOR CARRYING OUT THE INVENTION

A cleaning method of a susceptor (hereinafter simply referred to as the “cleaning method”) according to the present invention is described in detail below. This cleaning method is applied to, for example, cleaning of a susceptor 3 that supports a silicon wafer as a semiconductor substrate 2 (the silicon wafer is hereinafter referred to as the “wafer”, and denoted by the same reference numeral as the semiconductor substrate 2) during RTA treatment using an RTA apparatus 1 illustrated in FIG. 9. The susceptor 3 used in this embodiment is a member including a base material 3a which is silicon carbide (SiC) formed into a ring shape. The susceptor 3 is mounted on a support cylinder 4 disposed in the RTA apparatus 1. A plurality of lamps 5 for heating is disposed in the RTA apparatus 1. The RTA apparatus 1 is configured such that after the temperature of the wafer 2 supported by the susceptor 3 is rapidly raised to a high heat treatment temperature in an oxygen atmosphere, the wafer 2 is held at the heat treatment temperature for a predetermined time, and the temperature is rapidly lowered from the heat treatment temperature.

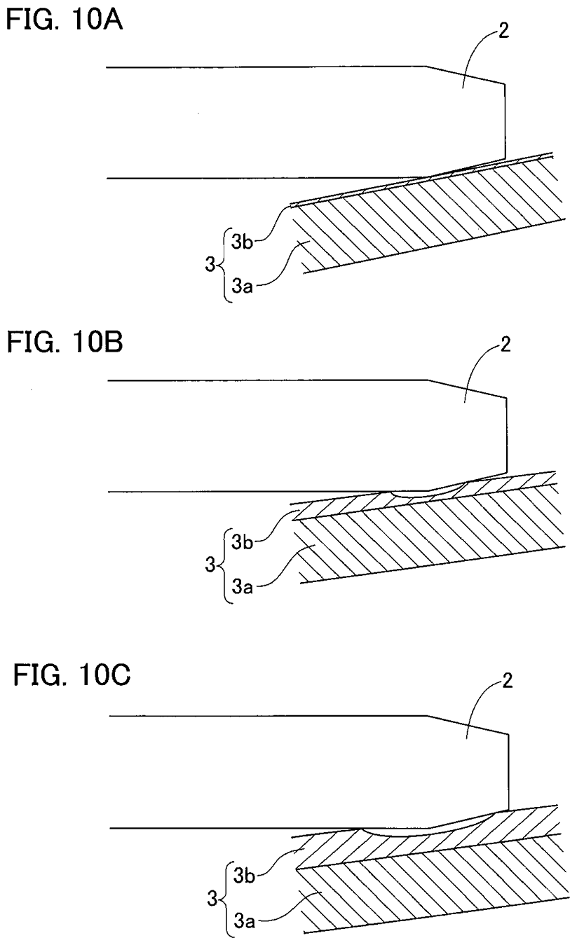

An oxide film 3b (initial thickness of about 0.1 μm) is formed in advance on the surface of the base material 3a of the susceptor 3. As illustrated in FIGS. 10A to 10C, the thickness of the oxide film 3b gradually increases as a result of repeated use in RTA treatment in the oxygen atmosphere. For example, if RTA treatment is performed in an oxygen atmosphere (preferably, an oxygen partial pressure of 20% or more and 100% or less) at a heat treatment temperature of 1250° C. or more and 1350° C. or less and a retention time of 1 second or more and 60 seconds or less at the heat treatment temperature, an oxide film 3b of about 0.1 nm grows newly each time the RTA treatment is performed. That is, an oxide film 3b of about 20 μm is formed on the surface of the susceptor 3 which was subjected to the RTA treatment 200,000 times.

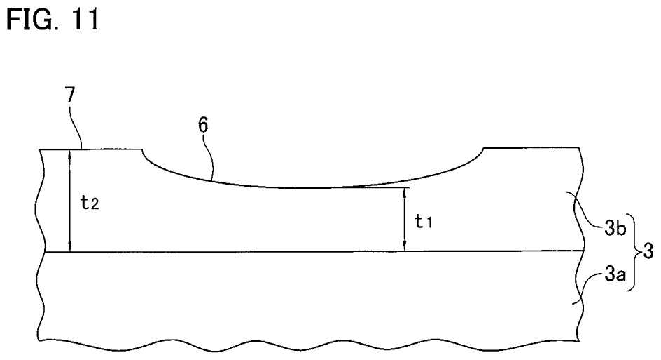

The thickness of the oxide film 3b formed on the surface of the susceptor 3 is not uniform when RTA treatment is performed several times. As illustrated in FIG. 11, the oxide film 3b tends to be thinner in a contact region 6 (portion recessed into a concave shape in FIG. 11) in which the susceptor 3 and the wafer 2 are in contact with each other, than in a non-contact region 7 other than the contact region 6. For example, it is empirically known that when an oxide film 3b having a film thickness t2 of about 20 μm is formed in the non-contact region 7, an oxide film 3b having a film thickness t1 of about 6 to 15 μm is formed in the contact region 6.

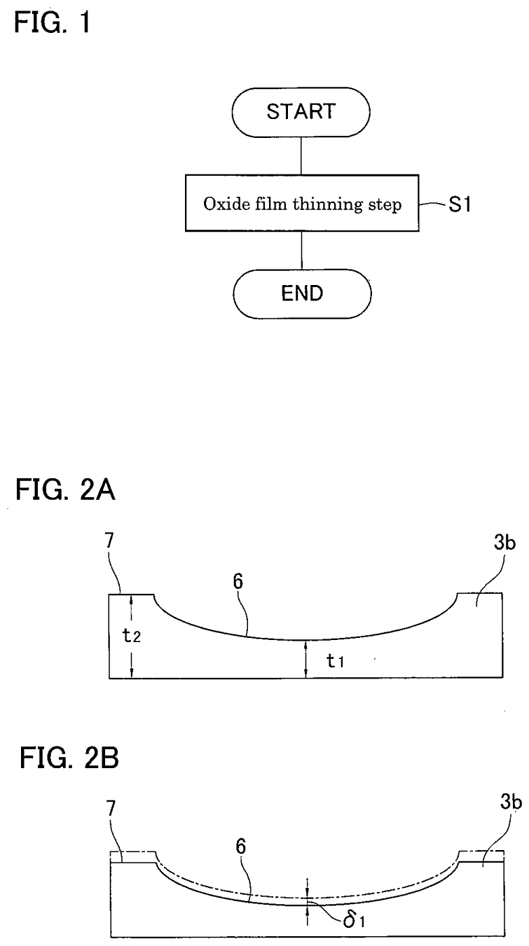

FIG. 1 illustrates a flow of a first embodiment of the cleaning method of the susceptor 3 according to the present invention. This cleaning method is a cleaning method for removing an oxide film 3b that is formed on the surface of the susceptor 3 by performing RTA treatment several times; and includes an oxide film thinning step S1. As illustrated in FIG. 2A, the oxide film thinning step S1 is applied to the susceptor 3 in which the thickness of the oxide film 3b after RTA treatment is thinner/smaller in the contact region 6, in which the susceptor 3 is in contact with the wafer 2, than in the non-contact region 7 other than the contact region 6; and as illustrated in FIG. 2B, etching (etching amount 61) is performed while paying attention such that the base material 3a (SiC) of the susceptor 3 is not exposed in the contact region 6, in which the oxide film 3b is thinner. By performing the oxide film thinning step S1 in a state in which a crack extending from the surface of the oxide film 3b toward the interior is not present in the oxide film 3b after RTA treatment, etching progresses only from the surface of the oxide film 3b. If a crack is present in the oxide film 3b, the crack can be removed by, for example, etching or polishing. Especially in the case of etching, since a chemical solution infiltrates into the oxide film through the crack, the crack can be efficiently removed.

The oxide film thinning step S1 can be performed at an appropriate frequency, but in this embodiment, the oxide film thinning step S1 is performed each time an oxide film 3b having a predetermined thickness within the range of 0.1 μm or more and 5 μm or less is newly formed in the contact region 6 by performing RTA treatment several times, more preferably, each time an oxide film 3b having a predetermined thickness within the range of 1 μm or more and 1.5 μm or less is newly formed. More specifically, for example, the oxide film thinning step S1 can be performed as follows: the oxide film thinning step S1 is performed once each time an oxide film 3b of 1.2 μm is newly formed.

The etching method in the oxide film thinning step S1 can be appropriately determined, and, for example, wet etching or dry etching using hydrogen fluoride or ammonium fluoride can be used. The amount of removal of the oxide film 3b in the oxide film thinning step S1 is preferably within the range of the thickness of an oxide film 3b newly formed in the contact region 6 by performing RTA treatment several times so that the base material 3a of the susceptor 3 is not exposed especially in the contact region 6. More specifically, for example, an oxide film 3b having a predetermined thickness within the range of 0.5 μm or more and 0.75 μm or less can be removed each time an oxide film 3b having a predetermined thickness within the range of 1 μm or more and 1.5 μm or less is newly formed. If an oxide film 3b is re-formed in a state in which the oxide film 3b of the susceptor 3 is entirely removed and the entire base material 3a is exposed, the susceptor 3 could break. Therefore, it is preferable not to expose the base material 3a of the susceptor 3 as much as possible in the oxide film thinning step S1.

The surface roughness Ra of the oxide film 3b (oxide film 3b remaining in the susceptor 3) after the oxide film thinning step S1 (after etching) is within the range of 0.01 μm or more and 1 μm or less.

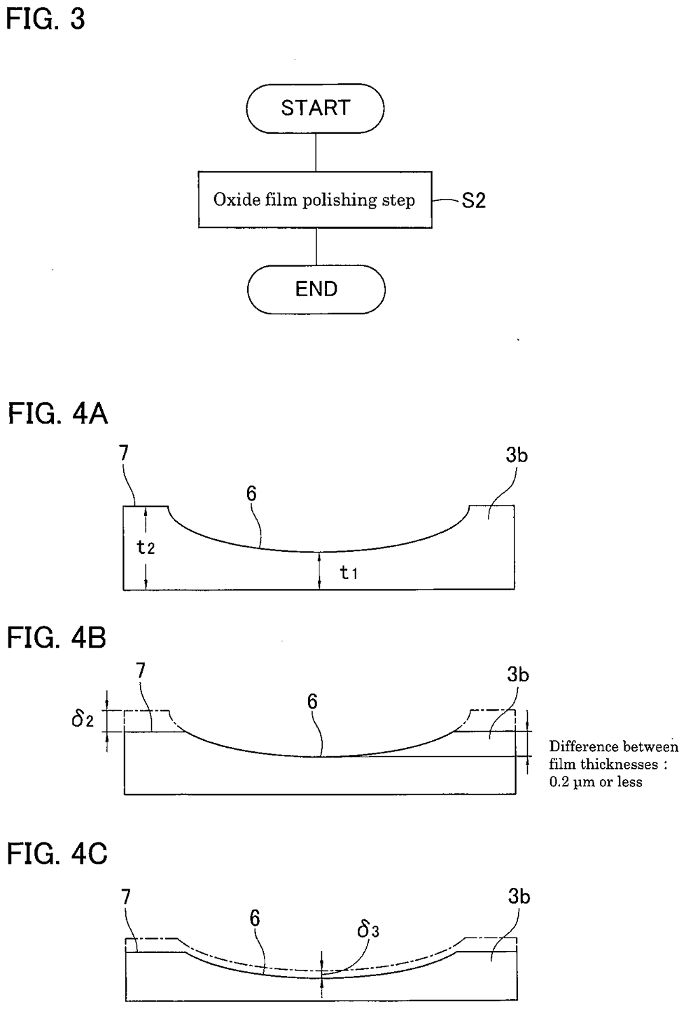

FIG. 3 illustrates a flow of a second embodiment of the cleaning method according to the present invention. This cleaning method is a cleaning method for removing an oxide film 3b that is formed on the surface of the susceptor 3 by performing RTA treatment several times; and includes an oxide film polishing step S2. As illustrated in FIG. 4A, the oxide film polishing step S2 is applied to the susceptor 3 in which the thickness of the oxide film 3b after RTA treatment is thinner in the contact region 6, in which the susceptor 3 is in contact with the wafer 2, than in the non-contact region 7 other than the contact region 6; and as illustrated in FIG. 4B, polishing (polishing amount δ2) is performed each time an oxide film 3b having a predetermined thickness is newly formed in the non-contact region 7 by performing RTA treatment several times.

The oxide film polishing step S2 can be performed at an appropriate frequency, but in this embodiment, the oxide film polishing step S2 is performed each time an oxide film 3b having a predetermined thickness within the range of 1 μm or more and 40 μm or less is newly formed in the non-contact region 7 by performing RTA treatment several times, more preferably, each time an oxide film 3b having a predetermined thickness within the range of 1 μm or more and 30 μm or less is newly formed. More specifically, for example, the oxide film polishing step S2 can be performed as follows: the oxide film polishing step S2 is performed once each time an oxide film 3b of 15 μm is newly formed.

The polishing method in the oxide film polishing step S2 can be appropriately determined, and, for example, chemical mechanical polishing (CMP) can be used. The amount of removal of the oxide film 3b in the oxide film polishing step S2 is preferably within the range of the thickness of an oxide film 3b newly formed in the non-contact region 7 by performing RTA treatment several times so that the base material 3a is not exposed to the surface of the susceptor 3. More specifically, for example, each time an oxide film 3b having a predetermined thickness within the range of 1 μm or more and 30 μm or less is newly formed, an oxide film 3b having a predetermined thickness within the range of 0.5 μm or more and 20 μm or less can be removed (within the range of the thickness of the oxide film 3b formed newly).

In the oxide film polishing step S2, the difference between the thicknesses of the portion of the oxide film 3b in the contact region 6 and the portion of the oxide film 3b in the non-contact region 7 is 5 μm or less, more preferably 2 μm or less (2 μm in this embodiment).

After polishing in the oxide film polishing step S2, contamination (oxide film fragments, metal, and the like) resulting from the polishing could remain on the surface of the susceptor 3. Therefore, as illustrated in FIG. 4C, etching (etching amount δ3) for removing the contamination on the surface of the susceptor 3 is performed subsequent to the polishing. This etching is generally wet etching using hydrofluoric acid, and 0.3 μm or more, more preferably 0.5 μm or more of the polished surface is removed. If the amount of removal thereof is less than 0.3 μm, the contamination resulting from the polishing cannot be sufficiently removed, and due to this, the contamination on the susceptor 3 could be transferred to the wafer during RTA treatment.

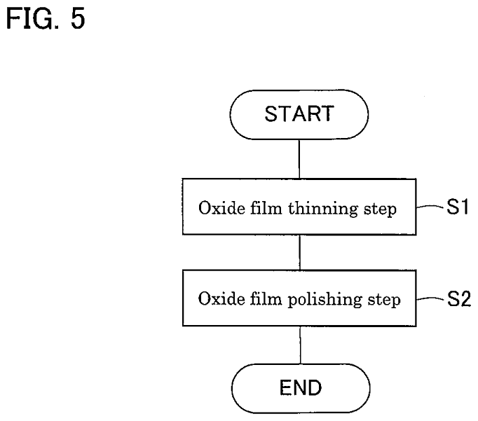

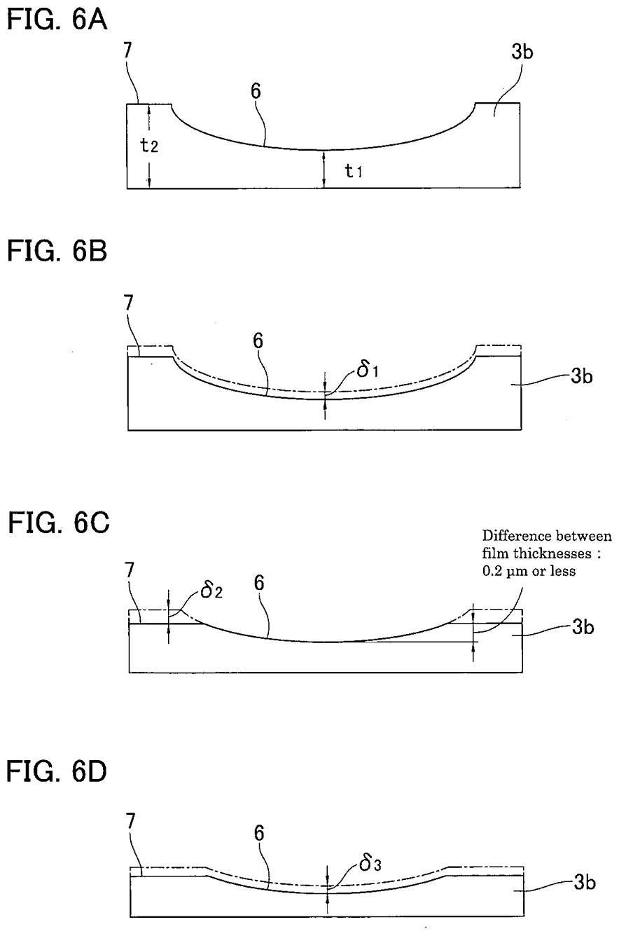

FIG. 5 illustrates a flow of a third embodiment of the cleaning method according to the present invention. This cleaning method is a cleaning method for removing an oxide film 3b that is formed on the surface of the susceptor 3 by performing RTA treatment several times; and includes an oxide film thinning step S1 and an oxide film polishing step S2. As illustrated in FIG. 6A, the oxide film thinning step S1 is applied to the susceptor 3 in which the thickness of the oxide film 3b after RTA treatment is thinner/smaller in the contact region 6, in which the susceptor 3 is in contact with the wafer 2, than in the non-contact region 7 other than the contact region 6; and as illustrated in FIG. 6B, etching is performed while paying attention such that the base material 3a (SiC) of the susceptor 3 is not exposed in the contact region 6, in which the oxide film 3b is thinner. In the oxide film polishing step S2, as illustrated in FIG. 6C, polishing is performed within the range of the thickness of the oxide film 3b remaining in the non-contact region 7 after the oxide film thinning step S1. As illustrated in FIG. 6D, etching for removing contamination on the surface of the susceptor 3 is additionally performed subsequent to the polishing.

Since the treatment conditions of the oxide film thinning step S1, the oxide film polishing step S2, and etching after the oxide film polishing step S2 are common to the treatment conditions described in the oxide film thinning step S1 of the first embodiment and the oxide film polishing step S2 of the second embodiment, redundant description is omitted.

The effects of the cleaning method described in the first embodiment were verified (Experiment 1). (1) conditions of RTA treatment; (2) used wafers; and (3) used susceptors made of SiC (Comparative Example 1 and Example 1) in this verification experiment are described below.

(1) Conditions of RTA treatment
Oxygen atmosphere (oxygen partial pressure within the range of 20% or more and 100% or less)
Maximum temperature: 1300° C. (within the range of not less than 1250° C. and not more than the melting point of silicon wafers)
Retention time at maximum temperature: 30 seconds (within the range of 1 second or more and 60 seconds or less)
Temperature dropping rate: 120° C./sec

### (2) Used Wafers

Silicon wafers sliced from the same silicon single crystal ingot were used in both Comparative Example 1 and Example 1

### (3) Used Susceptors Made of SiC

Comparative Example 1: A susceptor (oxide film thickness of about 20 μm; surface roughness Ra of 3 μm) that was continuously used 200,000 times in the above RTA treatment
Example 1: A susceptor (surface roughness Ra of 0.1 μm) that was subjected to cleaning (an oxide film was removed by 0.5 to 1 μm by etching with 5% hydrogen fluoride for 15 to 30 minutes according to the growth of the oxide film) every 40,000 times of use in the above RTA treatment, and that was used 200,000 times in total

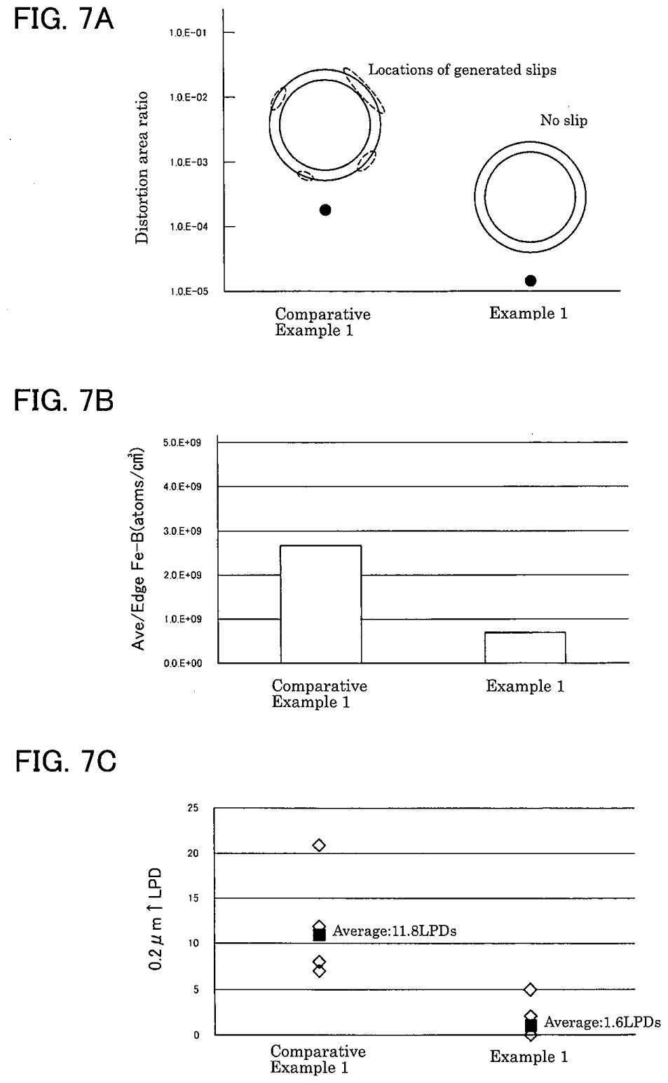

The results of the above verification experiment (Experiment 1) are shown in FIGS. 7A to 7C. FIG. 7A illustrates a measurement result obtained by scanning infrared depolarization (SIRD). FIG. 7B illustrates a measurement result obtained by surface photovoltage (SPV). FIG. 7C illustrates a measurement result obtained by a surface inspection apparatus (apparatus name: SPx).

As illustrated in FIG. 7A, in Comparative Example 1, since cleaning of the susceptor 3 was not performed, distortions occurred at the outermost periphery of the wafer 2 due to many slips generated from the surroundings of the wafer 2. In contrast thereto, in Example 1, since cleaning of the susceptor 3 was performed every predetermined number of times of treatment (40,000 times), generation of slips was reduced, and the distortion area ratio of the wafer 2 was reduced to 1×10⁻⁵ that is the measurement lower limit value of SIRD. Also, as illustrated in FIG. 7B, it was confirmed that the bulk Fe concentration in the outermost periphery of the wafer after the RTA treatment is about 70% lower in Example 1 than in Comparative Example 1. Also, as illustrated in FIG. 7C, it was confirmed that the number of LPDs having a size exceeding 0.2 μm is about 90% lower in Example 1 than in Comparative Example 1. It was confirmed that by performing cleaning on the susceptor 3 according to Example 1 every 40,000 times of the RTA treatment, the susceptor 3 was usable in the RTA treatment without deteriorating the quality of the wafer 2, up to about 400,000 times in total.

Next, the effects of the cleaning method described in the second embodiment were verified (Experiment 2). (1) conditions of RTA treatment; (2) used wafers; and (3) used susceptors made of SiC (Comparative Example 2 and Example 2) in this verification experiment are described below.

### (1) Conditions of RTA Treatment (the Same Treatment Conditions as Used in Experiment 1)

Oxygen atmosphere (oxygen partial pressure within the range of 20% or more and 100% or less)
Maximum temperature: 1300° C. (within the range of not less than 1250° C. and not more than the melting point of silicon wafers)
Retention time at maximum temperature: 30 seconds (within the range of 1 second or more and 60 seconds or less)
Temperature dropping rate: 120° C./sec

### (2) Used Wafers

Silicon wafers (10 silicon wafers) sliced from the same silicon single crystal ingot were used in each of Comparative Example 2 and Example 2

### (3) Used Susceptors Made of SiC

Comparative Example 2: A susceptor (oxide film thickness of about 28 μm) that was continuously used 250,000 times in the above RTA treatment
Example 2: A susceptor (surface roughness Ra of 0.1 μm) obtained by, after the surface of the susceptor according to Comparative Example 2 was polished by 10 μm by CMP, removing an oxide film by 1 μm by etching using 5% hydrogen fluoride for 30 minutes

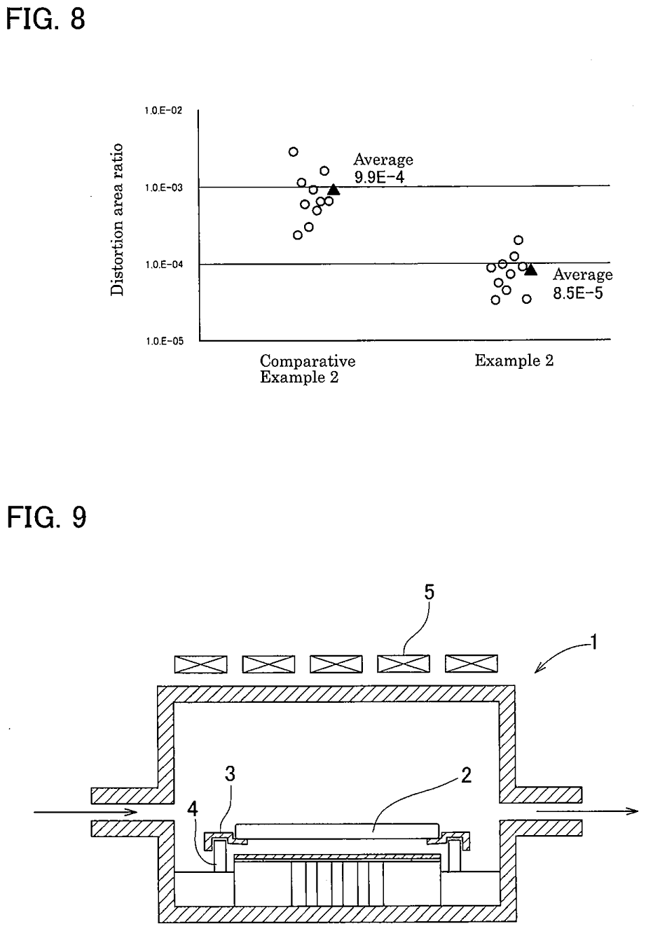

The results of the above verification experiment (Experiment 2) are shown in FIG. 8. FIG. 8 illustrates a measurement result obtained by SIRD. In Comparative Example 2, since cleaning of the susceptor 3 was not performed, distortions occurred at the outermost periphery of the wafer 2 due to many slips generated from the surroundings of the wafer 2. In contrast thereto, in Example 2, since the surface of the susceptor 3 was polished by a predetermined amount so as to reduce the difference between the thicknesses of the portion of the oxide film 3b in the contact region 6 and the portion of the oxide film 3b in the non-contact region 7, and the oxide film 3b was removed by a predetermined amount by etching, the distortion area ratio of the wafer 2 was reduced by 91%.

The thickness of the oxide film 3b after RTA treatment is thinner/smaller in the contact region 6, in which the susceptor 3 is in contact with the wafer 2, than in the non-contact region 7 other than the contact region 6, and the cleaning method according to the present invention includes the oxide film thinning step S1 of removing the oxide film 3b by etching such that the base material 3a of the susceptor 3 is not exposed in the contact region 6. Therefore, the boundary between the portion of the oxide film 3b formed in the contact region 6 and the portion of the oxide film 3b formed in the non-contact region 7 is smooth, and support of the wafer 2 by the susceptor 3 is stabilized. Also, the concentration of the self-weight stress and the thermal stress of the wafer 2 are alleviated. Therefore, generation of slips during RTA treatment is reduced, and the quality of the wafer 2 improves.

Also, with respect to the cleaning method according to the present invention, each time an oxide film 3b having a predetermined thickness within the range of 0.1 μm or more and 5 μm or less is newly formed in the contact region 6, in the oxide film thinning step S1, the oxide film 3b is removed within the range of the thickness of the oxide film 3b newly formed in the contact region 6. Therefore, it is possible to extend the life of the susceptor 3, and to ensure high quality of the wafer 2 subjected to RTA treatment using the susceptor 3.

Also, with respect to the cleaning method according to the present invention, since the oxide film thinning step S1 is performed in a state in which a crack extending from the surface of the oxide film 3b toward the interior is not present in the oxide film 3b after RTA treatment, etching progresses only from the surface of the oxide film 3b, that is, a situation does not occur in which an etching solution infiltrates into a crack, and etching progresses from the interior of the oxide film 3b. Therefore, it is possible to easily control the film thickness of the oxide film 3b in the oxide film thinning step S1, and to prevent non-uniformity of the oxide film thickness.

The cleaning method according to the present invention further includes the oxide film polishing step S2, in which the oxide film 3b on the surface of the susceptor 3 is removed by polishing, subsequent to the oxide film thinning step S1. Therefore, the portion of the oxide film 3b in the non-contact region 7, in which the film thickness is larger, is first polished so as to reduce the difference between the oxide film thicknesses in the contact region 6 and the non-contact region 7. This alleviates the concentration of the self-weight stress and the thermal stress of the wafer 2 due to the difference in oxide film thickness, thus further reducing generation of slips during RTA treatment.

Especially each time an oxide film 3b having a predetermined thickness within the range of 1 μm or more and 30 μm or less is newly formed by RTA treatment in the non-contact region 7, in the oxide film polishing step S2, the oxide film 3b is removed within the range of the thickness of the oxide film 3b newly formed in the non-contact region 7 such that the difference between the thicknesses of the portion of the oxide film 3b in the contact region 6 and the portion of the oxide film 3b in the non-contact region 7 is set to 5 μm or less. Therefore, the portion of the oxide film 3b in the non-contact region 7, in which the film thickness is larger is first polished so as to reduce the difference between the oxide film thicknesses in the contact region 6 and the non-contact region 7. This alleviates the concentration of the self-weight stress and the thermal stress of the wafer 2 due to the difference in oxide film thickness, this further reducing generation of slips during RTA treatment.

Also, the thickness of the oxide film 3b after RTA treatment is thinner/smaller in the contact region 6, in which the susceptor 3 is in contact with the wafer 2, than in the non-contact region 7 other than the contact region 6, and the cleaning method according to the present invention includes the oxide film polishing step S2, in which each time an oxide film 3b having a predetermined thickness within the range of 1 μm or more and 30 μm or less is newly formed by RTA treatment in the non-contact region 7, the oxide film 3b is removed within the range of the thickness of the oxide film 3b newly formed in the non-contact region 7 such that the difference between the thicknesses of the portion of the oxide film 3b in the contact region 6 and the portion of the oxide film 3b in the non-contact region 7 is set to 5 μm or less. Therefore, the difference between the oxide film thicknesses in the contact region 6 and the non-contact region 7 decreases, the concentration of the self-weight stress and the thermal stress of the wafer 2 due to the difference in oxide film thickness are alleviated, and generation of slips during RTA treatment is further reduced. Especially by setting the difference between the thicknesses of the portions of the oxide film 3b in the contact region 6 and in the non-contact region 7 to 5 μm or less, it is possible to stably support the wafer 2, and thus effectively further reduce generation of slips during RTA treatment.

In the cleaning method according to the present invention, since the surface roughness Ra of the oxide film 3b formed on the susceptor 3 is within the range of 0.01 μm or more and 1 μm or less, it is possible to reduce generation of slips due to welding between the wafer 2 and the susceptor 3 during RTA treatment and/or the concentration of the self-weight stress.

The above cleaning method is especially suitable for cleaning of the susceptor 3 in which the heat treatment temperature is within the range of not less than 1250° C. and not more than the melting point of the wafer 2, the retention time at the maximum temperature is within the range of 1 second or more and 60 seconds or less, and the susceptor 3 is used in RTA treatment performed in an atmosphere gas containing oxygen.

While, in the above description, the susceptor 3 used in the RTA apparatus 1 is exemplified, and the cleaning method thereof is described, this cleaning method may also be applicable to susceptors 3 used in batch-type heat treatment furnaces. Also, the material of the susceptor 3 is not limited to SiC. This cleaning method may be applicable to susceptors 3 made of another material.

The above-described embodiments are mere examples in every respect, and the present invention is not limited thereto. The scope of the present invention is indicated by not the above description but the claims, and should be understood to include all modifications within the meaning and scope equivalent to the scope of the claims.

### DESCRIPTION OF REFERENCE NUMERALS

1: RTA apparatus
2: Semiconductor substrate (wafer)
3: Susceptor
3a: Base material
3b: Oxide film
4: Support cylinder
5: Lamp
6: Contact region
7: Non-contact region
S1: Oxide film thinning step
S2: Oxide film polishing step

1. A cleaning method of a susceptor supporting a semiconductor substrate during heat treatment, and comprising:
a base material; and
an oxide film formed on a surface of the base material,
wherein a thickness of the oxide film after the heat treatment is smaller in a contact region in which the susceptor is in contact with the semiconductor substrate, than in a non-contact region other than the contact region, and
wherein the cleaning method comprises an oxide film thinning step of removing the oxide film by etching such that the base material is not exposed in the contact region.

2. The cleaning method of the susceptor according to claim 1, wherein each time the oxide film having a predetermined thickness within a range of 0.1 μm or more and 5 μm or less is newly formed in the contact region by the heat treatment, in the oxide film thinning step, the oxide film is removed within a range of the thickness of the oxide film newly formed in the contact region.

3. The cleaning method of the susceptor according to claim 1, wherein the oxide film thinning step is performed in a state in which a crack extending from a surface of the oxide film toward an interior of the oxide film is not present in the oxide film after the heat treatment.

4. The cleaning method of the susceptor according to claim 1, further comprising an oxide film polishing step of removing the oxide film on a surface of the susceptor by polishing, subsequent to the oxide film thinning step.

5. The cleaning method of the susceptor according to claim 4, wherein each time the oxide film having a predetermined thickness within a range of 1 μm or more and 30 μm or less is newly formed in the non-contact region by the heat treatment, in the oxide film polishing step, the oxide film is removed within the range of the thickness of the oxide film newly formed in the non-contact region such that a difference between thicknesses of a portion of the oxide film in the contact region and a portion of the oxide film in the non-contact region is 5 μm or less.

6. A cleaning method of a susceptor supporting a semiconductor substrate during heat treatment, and comprising:
a base material; and
an oxide film formed on a surface of the base material,
wherein a thickness of the oxide film after the heat treatment is smaller in a contact region in which the susceptor is in contact with the semiconductor substrate, than in a non-contact region other than the contact region, and
wherein the cleaning method comprises an oxide film polishing step in which each time the oxide film having a predetermined thickness within a range of 1 μm or more and 30 μm or less is newly formed in the non-contact region by the heat treatment, the oxide film is removed within a range of the thickness of the oxide film newly formed in the non-contact region such that a difference between thicknesses of a portion of the oxide film in the contact region and a portion of the oxide film in the non-contact region is 5 μm or less.

7. The cleaning method of the susceptor according to claim 1, wherein a surface roughness Ra of the oxide film formed in the susceptor is within a range of 0.01 μm or more and 1 μm or less.

8. The cleaning method of the susceptor according to claim 1, wherein a heat treatment temperature is within a range of not less than 1250° C. and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen.

9. The cleaning method of the susceptor according to claim 2, wherein a surface roughness Ra of the oxide film formed in the susceptor is within a range of 0.01 μm or more and 1 μm or less.

10. The cleaning method of the susceptor according to claim 3, wherein a surface roughness Ra of the oxide film formed in the susceptor is within a range of 0.01 μm or more and 1 μm or less.

11. The cleaning method of the susceptor according to claim 4, wherein a surface roughness Ra of the oxide film formed in the susceptor is within a range of 0.01 μm or more and 1 μm or less.

12. The cleaning method of the susceptor according to claim 5, wherein a surface roughness Ra of the oxide film formed in the susceptor is within a range of 0.01 μm or more and 1 μm or less.

13. The cleaning method of the susceptor according to claim 6, wherein a surface roughness Ra of the oxide film formed in the susceptor is within a range of 0.01 μm or more and 1 μm or less.

14. The cleaning method of the susceptor according to claim 2, wherein a heat treatment temperature is within a range of not less than 1250° C. r and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen.

15. The cleaning method of the susceptor according to claim 3, wherein a heat treatment temperature is within a range of not less than 1250° C. r and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen.

16. The cleaning method of the susceptor according to claim 4, wherein a heat treatment temperature is within a range of not less than 1250° C. r and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen.

17. The cleaning method of the susceptor according to claim 5, wherein a heat treatment temperature is within a range of not less than 1250° C. r and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen.

18. The cleaning method of the susceptor according to claim 6, wherein a heat treatment temperature is within a range of not less than 1250° C. r and not more than a melting point of the semiconductor substrate, a retention time at a maximum temperature is within a range of 1 second or more and 60 seconds or less, and cleaning is performed on the susceptor used in rapid thermal annealing performed in an atmosphere gas containing oxygen.
